(19) United States
(12) Patent Application Publication
(10) Pub. No.: US 2025/0210972 A1
(43) Pub. Date: Jun. 26, 2025

(54) SEMICONDUCTOR SWITCHING DEVICE

(71) Applicant: SANKEN ELECTRIC CO., LTD., Niiza-Shi (JP)

(72) Inventors: Shohei OSAKA, Niiza-Shi (JP); Kiyokatsu SATO, Niiza-Shi (JP)

(73) Assignee: SANKEN ELECTRIC CO., LTD., Niiza-Shi (JP)

(21) Appl. No.: 19/074,525

(22) Filed: Mar. 10, 2025

Related U.S. Application Data
(63) Continuation of application No. PCT/JP2022/036397, filed on Sep. 29, 2022.

(51) Int. Cl. H02H 7/26; H02H 1/00

(52) U.S. Cl. CPC H02H 7/26; H02H 1/0007

(57) ABSTRACT

A semiconductor switching device according to one or more embodiments may include a switch that is connected between a power supply connected from outside of the semiconductor switching device and a load through an electric wire, and turns on and off power supply to the load, a load current detector that detects the load current flowing through the switch, and a square calculator that outputs a square value of the load current detected by the load current detector. In one or more embodiments, the switch may turn on and off the power supply to the load based on a control command.

### CROSS REFERENCE TO RELATED APPLICATIONS

This application is a continuation application of International Application No. PCT/JP2022/036397, filed on Sep. 29, 2022, the entire contents of which are incorporated herein by reference.

### BACKGROUND

The disclosure relates to a semiconductor switching device, particularly to a semiconductor switching device that protects electric wires, loads, and the semiconductor switches from excessive heat generation due to overcurrent.

The number of electronic devices installed in vehicles has been increasing in recent years. Electronic devices mounted on vehicles and the like are often electrically connected to the battery via wiring such as a harness. Temperature control of wiring is important because heat generation in wiring leads to serious accidents such as smoke and fire. The electronic device may be controlled on and off by a semiconductor switch having a current detection circuit. The load current detected by the current detection circuit is discretely detected by an MCU (Micro Controller Unit) provided separately for control, and the detected current value is multiplied and accumulated according to the preset heat generation model of the electric wire to protect the wires from overheating.

Japanese Patent Publication No. 5097229 (Patent Document 1) discloses an overheating protective device capable of obtaining the temperature of an electric wire with high accuracy without executing a square arithmetic process with a microcomputer or the like. When the voltage exceeds the triangle wave signal, the overheating protection device outputs the sense current to the thermal equivalent circuit, and accumulates a charge in the capacitor of the thermal equivalent circuit corresponding to the current value and the time the current has flowed; when the voltage is n-times higher, the time when the voltage exceeds the triangle wave signal is n-times longer, so the charge stored in the capacitor is proportional to the square of the sense current; thus, the voltage generated in the thermal equivalent circuit is proportional to the square of the load current and may be regarded as the estimated temperature of the load and wire circuit; for this reason, and it is disclosed that the temperature of the load and the electric wire circuit may be estimated without using a microcomputer or the like for square calculation.

### SUMMARY

With the increase in the number of electronic devices installed in vehicles, etc., the load on MCUs that control various electronic devices mounted on vehicles is increasing. In particular, when the MCU performs overheating protection control of all wires that electrically connect electronic devices, the computational load increases explosively. In particular, against the background of the increase in electronic devices installed in vehicles in recent years, 1) the computational load increases as the number of outputs of MCU semiconductor switches increases, and 2) the resources for analog-to-digital conversion (A/D conversion) for the MCU to capture the load current increase. The factors lead to an increase in the number of electronic devices and an increase in costs. In addition, since the load current is discretely detected, sufficient detection may not be performed for a short increase in the load current or surge fluctuations, resulting in a large error rate.

Further, in the technique disclosed in Patent Document 1, the amount of heat generated in the load is estimated, and the estimated heat amount is used to monitor the overheating state of the load and the wire. In this technology, many circuits are required for overheating determination.

A semiconductor switching device according to one or more embodiments may perform inexpensive and highly accurate load current square integration or wire temperature estimation while reducing resources for accurate wire temperature estimation.

A semiconductor switching device according to one or more embodiments may include a switch that is connected between a power supply connected from outside of the semiconductor switching device and a load through an electric wire, and turns on and off power supply to the load, a load current detector that detects the load current flowing through the switch, and a square calculator that outputs a square value of the load current detected by the load current detector. In one or more embodiments, the switch may turn on and off the power supply to the load based on a control command.

A semiconductor switching device according to one or more embodiments may include a switch connected between a power supply connected from outside of the semiconductor switching device and a load via an electric wire, and turning on and off the power supply to the load, a load current detector that detects the load current flowing through the switch, a first analog-to-digital conversion circuit that receives the load current detected by the load current detector and performs an analog-to-digital conversion, a square calculator that receives a digitally converted load current signal and outputs a squared value, a second analog-to-digital conversion circuit that receives an environmental temperature signal and performs analog-to-digital conversion, an arithmetic circuit that receives a digitally converted environmental temperature signal and the squared value, and estimates temperature of the electric wire based on the digitally converted environmental temperature signal and the squared value, an overheat protection circuit that receives information of the estimated temperature of the electric wire and outputs an overheat protection signal when a cut off of a current flowing through the electric wire is determined, and a controller that receives a control command from outside and control the switch based on the control command and the overheating protection signal.

### BRIEF DESCRIPTION OF DRAWINGS

FIG. 1A is a diagram illustrating a cross-sectional view of a temperature model of an electric wire used in a semiconductor switching device according to one or more embodiments, and FIG. 1B is a diagram illustrating an equivalent circuit of the temperature model of the electric wire shown in FIG. 1A, for example.

FIG. 2 is a diagram illustrating a relationship between a wire current and a wire temperature according to one or more embodiments.

FIG. 3 is a diagram illustrating a semiconductor switching device and a peripheral circuit according to one or more embodiments.

FIG. 4 is a diagram illustrating a square calculator according to one or more embodiments.

FIG. 5 is a diagram illustrating a semiconductor switching device and a peripheral circuit according to one or more embodiments.

FIG. 6 is a diagram illustrating a semiconductor switching device and a peripheral circuit according to one or more embodiments.

FIG. 7 is a diagram illustrating an example of a signal output by a charge and discharge circuit.

FIG. 8 is a diagram illustrating a semiconductor switching device and a peripheral circuit according to one or more embodiments.

FIG. 9 is a diagram illustrating a semiconductor switching device and a peripheral circuit according to one or more embodiments.

### DETAILED DESCRIPTION

A semiconductor switching device according to one or more embodiments is described with reference to the drawings.

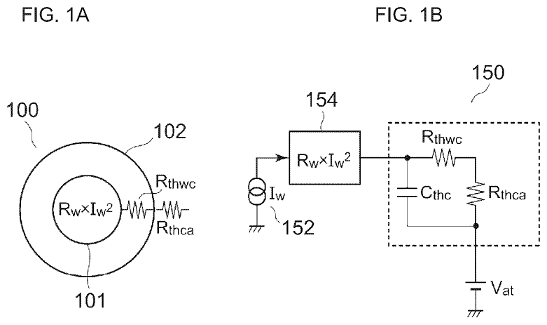

FIG. 1A is a cross-sectional view illustrating a temperature model of an electric wire used in a semiconductor switching device according to one or more embodiments. In FIG. 1A, for convenience of explanation, a cross-sectional view of an electric wire is shown. The wire 100 includes a conductor 101 that supplies current and transmits an electrical signal, and an insulator 102 that coats the conductor 101 so as to insulate the conductor 101 from the outside. When a current flows through the wire 100, a loss occurs obtained by multiplying the resistance value Rw of the conductor 101 by the square of the current value Iw flowing through the conductor 101. Most of the loss becomes thermal energy, and the wire 100 generates heat. A part of the generated loss is first transferred to the insulator 102 through a predetermined delay (Rthwc), and then dissipated as heat into the space (Rthca). Here, the electric wire is a wire that transmits electricity, and refers to a linear member that electrically connects electronic components to each other. In addition to general electric wires, wiring in printed circuit boards may also be included.

FIG. 1B is a diagram illustrating an equivalent circuit 150 of the temperature model of the electric wire shown in FIG. 1A, for example. The equivalent circuit 150 of the temperature model of the electric wire described above has a thermal resistance Rthwc of the insulator 102 and a thermal resistance Rthca radiating from the insulator 102 to the space between the current source Iw as a loss source and the voltage source Vat as an environmental temperature. The illustrated equivalent circuit includes a current source 152 that generates a current Iw, a circuit 154 that receives a current Iw and outputs Rw×Iw², and a thermal resistance Rthwc and thermal resistance Rthca that are electrically connected in series with the circuit 154, heat capacity Cthc connected in parallel with thermal resistance Rthwc and thermal resistance Rthca, and a voltage source Vat. In FIG. 1B, the equivalent circuit showing the temperature model of the electric wire is calculated using the conductor 101. Here, the radiation of heat from the insulator 102 into the space is often delayed from the generation of heat due to loss. For this reason, in the equivalent circuit of the temperature model, the heat capacity Cthc of the wire 100 is included. By including the heat capacitance Cthc, an equivalent circuit of a highly accurate temperature model may be provided.

Since the loss of the wire is proportional to the square of the current flowing through the wire, heat generation may increase significantly as the current increases. In this case, when the temperature of the conductor rises and reaches the smoke temperature of the insulator, which may cause smoking or other disturbances. In order to protect the wires from excessive heat generation, it is necessary to manage the temperature of the wires by estimating the temperature of the wires using a temperature model of the wires, and to protect them if necessary. On the other hand, in order to accurately estimate the temperature of the wires, it may be necessary to ensure the accuracy of various parameters of the model and the temperature estimation calculation in real time. But if the load current detection interval is shortened, the load on the MCU (Micro Controller Unit) and other processing operations increases, which increases the computing load. Therefore, it is necessary to reduce the computing load of the part.

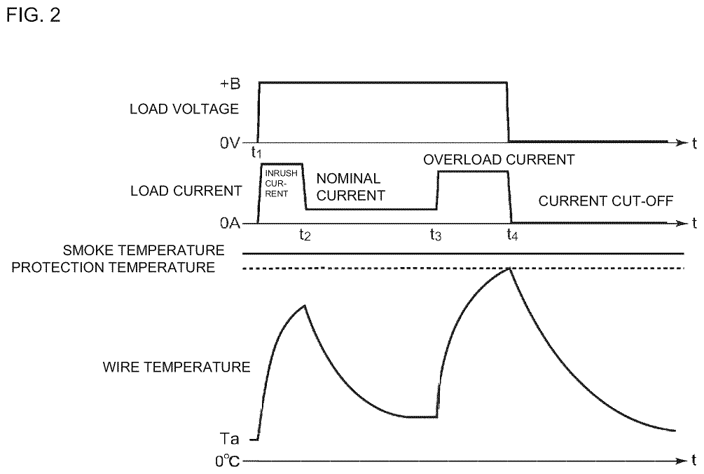

FIG. 2 is a diagram illustrating the relationship between the wire current and the wire temperature. In general, when the state in which no current flows through the wire for a certain period of time, the wire temperature reaches the ambient temperature Ta. The semiconductor switching device is turned on and the output voltage rises to the input voltage level (t1). Then, a current is supplied to the load, an inrush current flows through the load current, and the wire temperature rises rapidly. When the load current decreases and is maintained at the nominal current (t2), the wire temperature gradually decreases due to the decrease in wire loss, and the temperature reaches the ambient temperature Ta plus the temperature increased due to self-heating. Then, when an overload current flows through the wire (t3), the wire temperature rises again. When the wire temperature exceeds a certain value due to an increase in ambient temperature or an overload (t4), the temperature rises beyond the limit of the usable temperature of the insulator 102 covering the conductor 101, and there is a possibility that the wire may be damaged such as smoke. Therefore, a protection temperature is preset at a stage before the wire temperature reaches the smoke temperature, for example, the protection temperature is lower than the smoke temperature, and when the temperature reaches the protection temperature, the load current supplied to the load may be cut off. When the load current is cut off, the load voltage decreases and the wire temperature decreases.

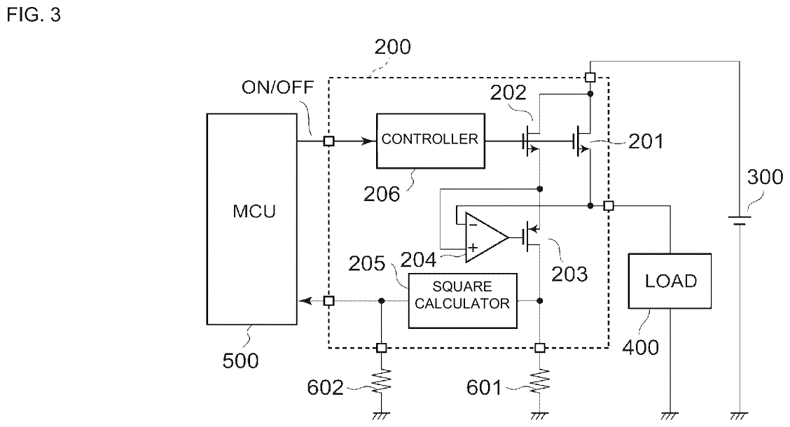

FIG. 3 is a diagram illustrating a semiconductor switching device 200 and a peripheral circuit according to one or more embodiments. As shown in FIG. 3, the semiconductor switching device 200 is electrically connected between the voltage source 300 and the load 400 provided outside the semiconductor switching device 200. The semiconductor switching device 200 includes the buffer circuit 204 and the transistor 203, and includes the load current detection circuit that detects a load current from the load 400, and the square calculator that receives a current from the transistor 203 and outputs a squared value of the received current signal. Further, the semiconductor switching device 200 includes the controller 206 that receives control commands from MCU (Micro Controller Unit) 500, and a switch that includes the transistors 201 and 202 that are controlled on and off by the controller 206. The voltage source 300 supplies a predetermined voltage to the semiconductor switching device 200. The voltage source 300 includes a device capable of supplying voltage, such as a battery mounted on a vehicle, for example. The load 400 includes, for example, various electronic devices mounted on a vehicle and powered from a battery via wires. When a voltage is supplied from the voltage source 300, a load current is supplied to the load 400 via the semiconductor switching device 200. The load 400 performs various operations when a load current is supplied.

As shown in FIG. 3, the gates of the transistors 201 and 202 are electrically connected to the controller 206. The drains of the transistors 201 and 202 are electrically connected to the voltage source 300. The source of the transistor 201 is electrically connected to the load 400 and the buffer circuit 204, and the source of the transistor 202 is electrically connected to the buffer circuit 204. The gate of the transistor 203 is electrically connected to the buffer circuit 204, the source of the transistor 203 is electrically connected to the source of the transistor 202, and the drain of the transistor 203 is electrically connected to the square calculator 205. The resistor 601 is electrically connected to the drain of the square calculator 205 and the transistor 203, and the resistor 602 is electrically connected to the square calculator 205 and the MCU 500. The semiconductor switching device 200 may be encapsulated in one resin package.

Next, the operation of the semiconductor switching device 200 is described. First, the controller 206 receives control commands from the MCU 500 and performs various switch controls. The controller 206 outputs a drive voltage to the gates of the transistors 201 and 202 based on the control command. The transistors 201 and 202 are in the on-state when the transistors 201 and 202 receive a drive voltage at the gate. As a result, the voltage output by the voltage source 300 is supplied to the load 400. Thereby, a load current is supplied to the load 400. The load 400 performs various operations when a load current is supplied.

The buffer circuit 204 receives the outputs of the transistors 201 and 202. The buffer circuit 204 outputs a voltage corresponding to the difference in the voltage output by the transistors 201 and 202 to the transistor 203. The transistor 203 supplies a current to the square calculator 205 according to the voltage output by the buffer circuit 204. The square calculator 205 performs a square calculation based on the supplied current signal. Here, the square calculator 205 may supply a voltage signal proportional to the current level output by the transistor 203. In that case, the resistor 601 is connected from outside the semiconductor switching device 200. The square calculator 205 may receive the voltage value output by the transistor 203 and perform a squared operation based on the voltage signal. The resistor 602 may be provided inside the semiconductor switching device 200. The MCU 500 performs an analog-to-digital (A/D) conversion of the current value output by the square calculator 205, and calculates the loss of the wire electrically connecting the voltage source 300 and the load 400 based on the digitized current value. The MCU 500 estimates the temperature of the wire based on the calculated loss of the wire, determines whether or not the wire has reached the protection temperature based on the estimated temperature, and when the wire has reached the protection temperature is determined, the MCU 500 outputs a current cut-off voltage to the controller 206. The transistors 201 and 202 are turned off based on the current cut-off voltage. As a result, the current supply to the load 400 is cut off. Here, the MCU 500 may not be able to read the current value. In that case, the resistor 602 is connected from the outside of the semiconductor switching device 200. The MCU 500 may receive the voltage value output by the semiconductor switching device 200, and convert the voltage value to A/D, and calculate the loss of the wire that electrically connects the voltage source 300 and the load 400 based on the digitized current value. The resistor 602 may be provided inside the semiconductor switching device 200.

As described above, the semiconductor switching device 200 shown in FIG. 3 may perform a square integration of the load current necessary for calculating the loss of the wire that electrically connects the load 400 with a simple circuit configuration. As a result, while reducing the load on the MCU 500, it may be possible to perform inexpensive and high-precision load current square integration.

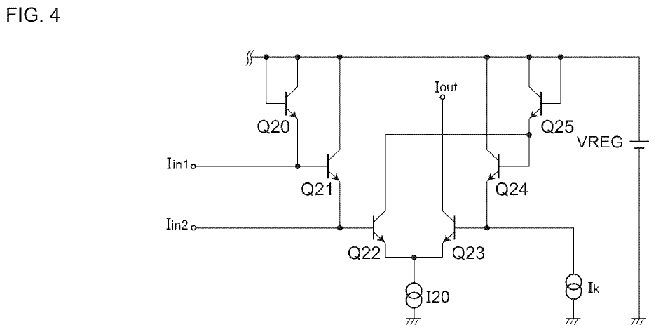

FIG. 4 is a diagram illustrating a square calculator according to one or more embodiments. In FIG. 4, the base and collector of the transistor Q20 are electrically connected to the power supply VREG, and the emitter of the transistor Q20 is electrically connected to the input terminal Iin1 and the base of the transistor Q21. The collector of the transistor Q21 is electrically connected to the power supply VREG, and the emitter is electrically connected to the input terminal Iin2 and the base of the transistor Q22. The emitter of the transistor Q22 is electrically connected to the emitter of the transistor Q23 and one end of the current source 120. The collector of the transistor Q22 is electrically connected to the base of the transistor Q24 and the emitter of the transistor Q25.

The base of the transistor Q23 is electrically connected to the current source Ik and the emitter of the transistor Q24, and the collector of the transistor Q23 is electrically connected to the output terminal Iout. The collector of transistor Q24 is electrically connected to the power supply VREG, and the base and collector of transistor Q25 are electrically connected to the power supply VREG. The transistors Q20, Q21, Q22, Q23, Q24, and Q25 include NPN-type transistors, but may be configured with other transistors, and constitute a multiplication and division circuit.

Next, the operation of the square calculator shown in FIG. 4 is described. First, a current Iin1 is input to the input terminal Iin1. The current Iin2 is input to the input terminal Iin2. The current source Ik outputs the current Ik. In this case, (Iin1×Iin2)/Ik is output to the output terminal Iout. If the current Iin1 and the current Iin2 are the current Iin, and the current Ik output by the current source Ik is a fixed value, for example, Ik=1/K, then Iout=K·Iin2, and may output the current of the square of the input current. However, the current output from the output terminal Iout is limited to the bias current of the current source 120 or less. The entire contents of the U.S. patent application Ser. No. 12/428,587, in particular the description of the square calculator, are incorporated herein by reference.

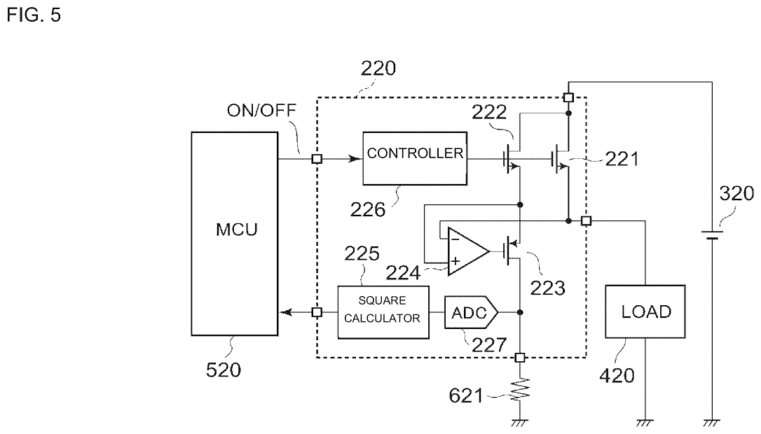

FIG. 5 is a diagram illustrating the semiconductor switching device 220 and peripheral circuits according to one or more embodiments. As shown, the semiconductor switching device 220 is electrically connected between a voltage source 320 and the load 420 provided outside the semiconductor switching device 220. The semiconductor switching device 220 includes the buffer circuit 224 and the transistor 223, and the load current detection circuit supplying the load 420, and the analog-to-digital converter (ADC) 227 that performs analog to digital conversion (A/D conversion) of the load current detected by the load current detection circuit, the square calculator 225 that receives a signal converted by the ADC 227 and outputs a squared value of the squared load current.

Further, the semiconductor switching device 220 includes the controller 226 that receives control commands from the MCU (Micro Controller Unit) 520, and the switch including the transistors 221 and 222 that are controlled on and off by the controller 226. The voltage source 320 supplies a predetermined voltage to the semiconductor switching device 220. The voltage source 320 includes a device capable of supplying voltage, such as a battery mounted on a vehicle. The load 420 includes, for example, various electronic devices mounted on the vehicle and powered from the battery via wires. When a voltage is supplied from the voltage source 320, a load current is supplied to the load 420 via the semiconductor switching device 220. The load 420 performs various operations when a load current is supplied. The resistor 621 is electrically connected to the drain of ADC 227 and transistor 223.

Next, the operation of the semiconductor switching device 220 is described. First, the controller 226 receives control commands from the MCU 520 and performs various switch controls. The controller 226 outputs a drive voltage to the gates of the transistors 221 and 222 based on the control command. Transistors 221 and 222 are in the on-state when they receive a drive voltage at the gate. As a result, the voltage output by the voltage source 320 is supplied to the load 420. Thereby, a load current is supplied to the load 420. The load 420 performs various operations when a load current is supplied.

The buffer circuit 224 receives the outputs of the transistors 221 and 222. The buffer circuit 224 outputs a voltage corresponding to the difference in voltage output by the transistors 221 and 222 to the transistor 223. The transistor 223 supplies current to the ADC 227 according to the voltage output by the buffer circuit 224. The ADC 227 performs an analog-to-digital conversion (A/D conversion) based on the supplied current signal and outputs a digital signal corresponding to the supplied current signal. Here, a current proportional to the load current of the transistor 221 is supplied to the resistor 621. The current signal converted to voltage by resistor 621 may be read by the ADC 227. The square calculator 225 receives the digital signal output from the ADC 227 and performs a squared operation based on the digital signal. The square calculator 225 outputs the result of the square operation to the MCU 520 as a digital signal. The MCU 520 receives the digital signal output by the square calculator 225, and calculates the loss of the wire that electrically connects the voltage source 320 and the load 420 based on the digital signal. The MCU 520 estimates the temperature of the wire based on the calculated loss of the wire, determines if the wire has reached the protection temperature based on the estimated temperature, and when the MCU 520 determines that the wire has reached the protection temperature, the MCU 520 outputs a current cut-off instruction to the controller 226. The controller 226 turns off the transistors 221 and 222 based on the current cut-off instruction. As a result, the current supply to the load 420 is cut off.

As described above, the semiconductor switching device 220 shown in FIG. 5 does not require the MCU 520 to perform A/D conversion because the MCU 520 receives the result of the digitized square operation. As a result, it may be possible to perform a square integration of the load current necessary for calculating the loss of the wire that electrically connects the load 420 with a simple circuit configuration, and while reducing the load on the MCU 520, it may be possible to perform inexpensive and highly accurate square integration of the load current.

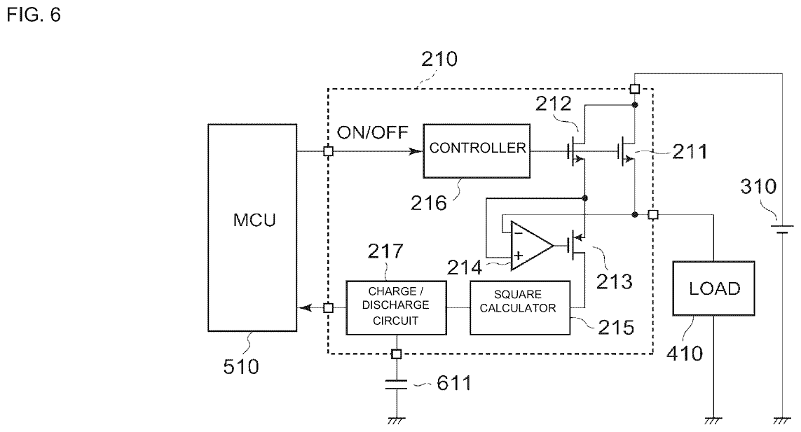

FIG. 6 is a diagram illustrating a semiconductor switching device 210 and peripheral circuits according to one or more embodiments. As shown, the semiconductor switching device 210 is electrically connected between the voltage source 310 and the load 410 provided outside the semiconductor switching device 210. The semiconductor switching device 210 includes the buffer circuit 214 and the transistor 213, and includes the load current detection circuit supplying the load 410, and the square calculator 215 that outputs the squared value of the detected load current. Further, the semiconductor switching device 210 includes the controller 216 that receives control commands from the MCU (Micro Controller Unit) 510, and the switch that includes the transistors 211 and 212 that are controlled on and off by the controller 216. The voltage source 310 supplies a predetermined voltage to the semiconductor switching device 210. The voltage source 310 includes a device capable of supplying voltage, such as a battery mounted on a vehicle, for example. The load 410 includes, for example, various electronic devices mounted on the vehicle and powered from the battery via wires. When a voltage is supplied from the voltage source 310, a load current is supplied to the load 410 via the semiconductor switching device 210. The load 410 performs various operations when the load current is supplied.

As shown, the semiconductor switching device 210 shown in FIG. 6 includes the square calculator 215 and the charge and discharge circuit 217 electrically connected to the MCU 510. The charge and discharge circuit 217 is electrically connected to a capacitor 611 connected from the outside of the semiconductor switching device 210, and charges and discharges the capacitor 611 in a predetermined voltage range.

Next, the operation of the semiconductor switching device 210 is described. First, the controller 216 receives control commands from the MCU 510 and performs various switch controls. The controller 216 outputs a drive voltage to the gates of the transistors 211 and 212 based on the control command. The transistors 211 and 212 are turned on when they receive a drive voltage at the gate. As a result, the voltage output by the voltage source 310 is supplied to the load 410. Thereby, a load current is supplied to the load 410. The load 410 performs various operations when the load current is supplied.

The buffer circuit 214 receives the outputs of the transistors 211 and 212. The buffer circuit 214 outputs a voltage corresponding to the difference in the voltage output by the transistors 211 and 212 to the transistor 213. The transistor 213 supplies a current to the square calculator 215 according to the voltage output by the buffer circuit 214. The square calculator 215 performs a squared operation based on the supplied current signal. Next, the charge and discharge circuit 217 converts the current signal output by the square calculator 215 into a pulse signal by charging and discharging the capacitor 611. By receiving a pulse signal, the MCU 510 may easily receive a signal from the semiconductor switching device 200. Here, the period of the pulse signal may be changed by adjusting the capacitance of the capacitor 611. Here, the capacitor 611 may compensate for the square operation of the wire loss. The radiation of heat from the insulator of the wire model into space is often lagged from the generation of heat due to loss. For this reason, by charging and discharging the capacitor 611, the heat capacity Cthc of the electric wire in the equivalent circuit of the temperature model may be considered. By considering the heat capacity Cthc, it may be possible to calculate the load current with high accuracy while reducing the load on the MCU 510. Further, the charge and discharge circuit 217 may perform a correction of the square calculation considering the heat capacity Cthc, and convert the corrected square calculation result to A/D, and output it to the MCU 510. The MCU 510 calculates the loss of the wire that electrically connects the voltage source 310 and the load 410 based on the current value digitized by the charge and discharge circuit 217. The MCU 510 estimates the temperature of the wire based on the calculated loss of the wire, determines if the wire has reached the protection temperature based on the estimated temperature, and when the MCU 510 determines that the wire has reached the protection temperature, the MCU 510 outputs a current cut-off instruction to the controller 216. The controller 216 turns off the transistors 211 and 212 based on the current cut-off instruction. As a result, the current supply to the load 410 is cut off. Here, the capacitor 611 may be provided externally to the semiconductor switching device 210 interchangeably. Since the capacitor 611 is interchangeable, it may accommodate a voltage source 310 having different output voltages and a load 410 having different thermal characteristics.

As described above, the semiconductor switching device 210 shown in FIG. 6 may perform a square integration related to the load current necessary for calculating the loss of the electric wire that electrically connects the load 410 with a simple circuit configuration. Here, the charge and discharge circuit 217 generates a pulse signal using the capacitor 611, so that the MCU 510 may easily receive a signal from the semiconductor switching device 210. Thereby, the MCU 510 may receive a signal from the semiconductor switching device 210 with a simple circuit configuration. Further, the charge and discharge circuit 217 may perform square integration considering the time difference of radiation of heat from the insulator of the wire thermal model to the space.

Compared to the semiconductor switch device embodiment shown in FIG. 3, the semiconductor switching device shown in FIG. 6 realizes a configuration in which even the multiply and accumulate calculation of wire losses is taken into the switching device by outputting the square calculation result of the load current as current and charging and discharging the capacitor. Here, the charge and discharge circuit 217 may output a pulse signal synchronized with the switching of charge and discharge of the capacitor 611 to the MCU 510.

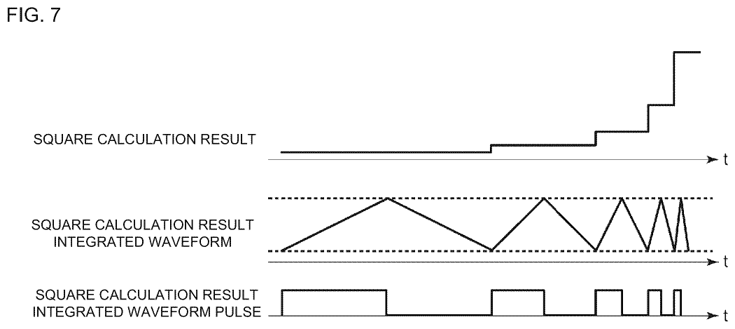

FIG. 7 is a diagram illustrating an example of a signal output by the charge and discharge circuit 217. The MCU 510 receives a square calculation result as shown in the figure from the semiconductor switching device 210. As shown in FIG. 6, the charge and discharge circuit 217 outputs a square calculation result pulse signal synchronized with the switching of charge and discharge of the capacitor 603. By outputting the pulse signal to the MCU 510, a low-frequency pulse signal is output when the wire current is low, and a high-frequency pulse signal is output when the wire current is large. By configuring in this way, the MCU 510 may continuously monitor the load current as an analog value, so that information including the effect of a short pulse surge current may be obtained. For this reason, accurate wire temperature estimation may be performed while suppressing the computational load of the MCU 510.

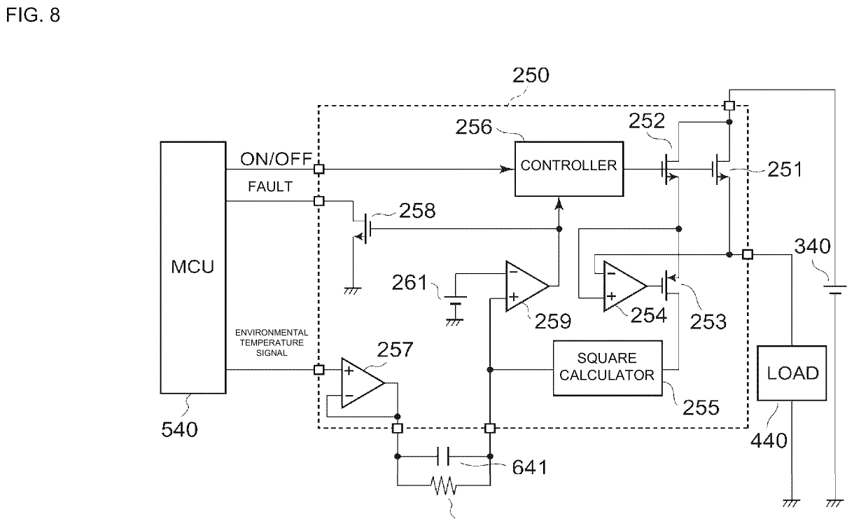

FIG. 8 is a diagram illustrating a semiconductor switching device 250 and peripheral circuits according to one or more embodiments. As shown, the semiconductor switching device 250 is electrically connected between a voltage source 340 and a load 440 provided outside the semiconductor switching device 250. The semiconductor switching device 250 includes a buffer circuit 254 and a transistor 253, and a load current detection circuit for detecting the load current from the load 440, and a square calculator 255 for outputting the squared value of the received current signal. Further, the semiconductor switching device 250 includes the controller 256 that receives a control command from the MCU (Micro Controller Unit) 540, and the switch including the transistors 251 and 252 that are controlled on and off by the controller 256. The voltage source 340 supplies a predetermined voltage to the semiconductor switching device 250. The voltage source 340 includes a device capable of supplying voltage, such as a battery mounted on a vehicle. The load 440 includes, for example, various electronic devices mounted on the vehicle and powered from the battery via wires. When a voltage is supplied from the voltage source 340, a load current is supplied to the load 440 via the semiconductor switching device 250. The load 440 performs various operations when the load current is supplied.

As shown, the semiconductor switching device 250 shown in FIG. 8 includes the buffer circuit 257, the transistor 258, and the comparator circuit 259. Further, the capacitor 641 and the resistor 642 are electrically connected to the buffer circuit 257, the square calculator 255 and the comparator circuit 259. These capacitors 641 and resistors 642 may be provided outside the semiconductor switching device 250 or may be provided inside of the semiconductor switching device 250.

Next, the operation of the semiconductor switching device 250 is described. First, the controller 256 receives control commands from the MCU 540 and performs various switch controls. The controller 256 outputs a drive voltage to the gates of the transistors 251 and 252 based on the control command. The transistors 251 and 252 are turned on when they receive a drive voltage at the gate. As a result, the voltage output by the voltage source 340 is supplied to the load 440. Thereby, a load current is supplied to the load 440. The load 440 performs various operations when the load current is supplied.

The buffer circuit 254 receives the outputs of transistors 251 and 252. The buffer circuit 254 outputs a voltage corresponding to the difference in the voltage output by the transistors 251 and 252 to the transistor 253. The transistor 253 supplies a current signal to the square calculator 255 according to the voltage output by the buffer circuit 254. The square calculator 255 performs a squared operation based on the supplied current signal. The buffer circuit 257 receives information related to the environmental temperature from the MCU 540 and outputs a corresponding voltage. The comparator circuit 259 outputs to the transistor 258 the result of comparing the estimated wire temperature signal, which is obtained by adding the current signal resulting from the square calculation on the capacitor 641 and the resistor 642 to the output of the buffer circuit 257, and the voltage output by the reference voltage source 261. Here, when the controller 256 receives a voltage greater than a predetermined amount from the comparator circuit 259, the controller 256 turns off the transistors 251 and 252. As a result, the current supply to the load 440 is cut off. Further, when the transistor 258 receives a voltage exceeding a predetermined amount from the comparator circuit 259, the transistor 258 notifies the MCU 540 of fault information (Fault).

Compared to the semiconductor switching device 200 shown in FIG. 3, the semiconductor switching device 250 shown in FIG. 8 has the buffer circuit 257 that buffers the input voltage signal reflecting the ambient temperature, a controller 256 which electrically connects a parallel circuit of the resistor 642 and the capacitor 641 reflecting an electric wire thermal model between a square calculator 255, and cuts off the transistors 251 and 252 when the output side voltage (estimated electric wire temperature) of the square calculator 255 exceeds a predetermined value. By obtaining ambient temperature information from the MCU 540, it may be possible to estimate and protect the wire temperature with the semiconductor switching device 250, so that protection of the wire may be realized with a smaller resource. In addition, by accurately estimating the temperature of the wire, it may be possible to estimate the temperature more accurately for the blowing characteristics of the fuse conventionally used to protect the wire, resulting in saving resources by optimizing the wire diameter and reducing transportation costs by reducing weight. Furthermore, by receiving ambient temperature information from the MSU 540, the semiconductor switching device 250 may realize wire temperature protection. For this reason, the control processing of the MCU increases with the increase in electronic devices installed in the vehicle in recent years, but by performing the above-described processing by the semiconductor switching device 250, it may be possible to control with a less expensive MCU.

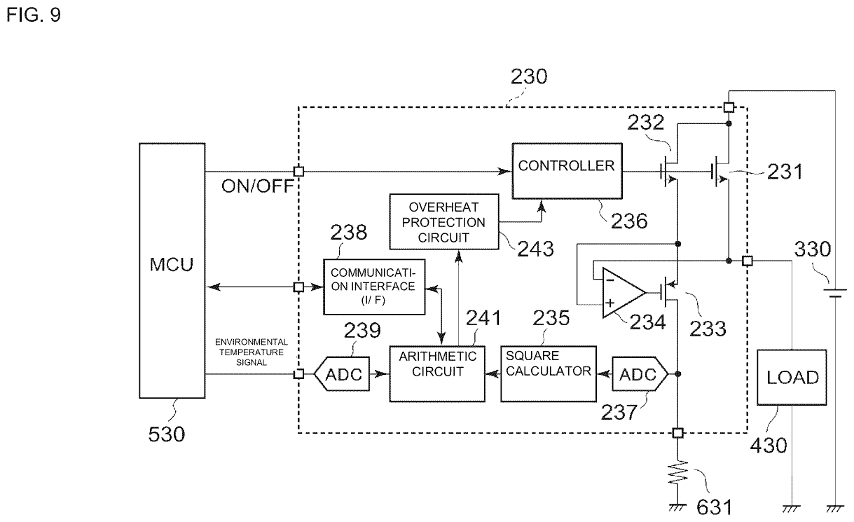

FIG. 9 is a diagram illustrating a semiconductor switching device 230 and peripheral circuits according to one or more embodiments. As shown, the semiconductor switching device 230 is electrically connected between the voltage source 330 provided outside the semiconductor switching device 230 and the load 430. The semiconductor switching device 230 includes the buffer circuit 234 and the transistor 233, and includes a load current detection circuit supplying to the load 430, and the square calculator 235 that outputs the squared value of the detected load current. Further, the semiconductor switching device 230 includes the controller 236 that receives control commands from the MCU (Micro Controller Unit) 530, and a switch including the transistors 231 and 232 that are controlled on and off by the controller 236. The voltage source 330 includes a device capable of supplying voltage, such as a battery mounted on a vehicle, for example. The load 430 includes, for example, various electronic devices mounted on the vehicle and powered from the battery via wires. When a voltage is supplied from the voltage source 330, a load current is supplied to the load 430 via the semiconductor switching device 230. The load 430 performs various operations when a load current is supplied.

As shown, the semiconductor switching device 230 shown in FIG. 9 includes the ADC 237 that receives a current from the transistor 233 and converts the received current signal into A/D, the square calculator 235 that receives the output of the ADC 237 and performs a square calculation, and the communication interface (I/F) 238 that communicates with the MCU 530, the ADC 239 that receives the environmental temperature information from the MCU 530 and outputs the environmental temperature signal by A/D conversion of the received environmental information, and the arithmetic circuit 241 that receives the calculation result of the square calculator 235 and the environmental temperature signal from the ADC 239 and performs various calculations, and the overheat protection circuit 243 that determines whether or not protection due to overheat is necessary for the wire that electrically connects the voltage source 330 and the load 430 based on the calculation result from the arithmetic circuit.

Next, the operation of the semiconductor switching device 230 is described. First, the controller 236 receives control commands from the MCU 530 and performs various switch controls. The controller 236 outputs a drive voltage to the gates of the transistors 231 and 232 based on the control command. The transistors 231 and 232 are turned on when they receive a drive voltage at the gate. As a result, the voltage output by the voltage source 330 is supplied to the load 430. Thereby, a load current is supplied to the load 430. The load 430 performs various operations when a load current is supplied.

The buffer circuit 234 receives the outputs of the transistors 231 and 232. The buffer circuit 234 outputs a voltage corresponding to the difference in the voltage output by the transistors 231 and 232 to the transistor 233. The transistor 233 supplies a load current signal to the ADC 237 according to the voltage output by the buffer circuit 234. The ADC 237 converts the received load current signal into A/D. The square calculator 235 performs a squared calculation based on the A/D converted current signal. The ADC 239 receives the environmental temperature information from the MCU 530, converts the received environmental information into A/D, and outputs an environmental temperature signal. The communication interface 238 receives various information from the MCU 530. The arithmetic circuit 241 receives a squared current signal, a signal from the communication interface 238, and an environmental temperature signal. The arithmetic circuit 241 includes, for example, a circuit for realizing the wire thermal model shown in FIG. 1B. Specifically, the voltage source Vat shown in FIG. 1B is calculated based on the environmental temperature signal. Further, the thermal resistance Rthwc as a coefficient for transferring heat to the insulator 102, the thermal resistance Rthca as a coefficient for dissipating heat as heat in the space, and the heat capacity Cthc as a delay coefficient are incorporated into the circuit in advance. By using these, the arithmetic circuit estimates the wire temperature. Here, the arithmetic circuit 241 may implement the thermal resistance Rthwc, the thermal resistance Rthca, and the heat capacity Cthc in a hardware operation, and it may also be implemented in software that estimates the wire temperature using various coefficients. The overheat protection circuit 243 receives information on the wire temperature estimated from the arithmetic circuit 241 and determines whether or not to cut off the current flowing through the wire in order to protect the wire due to overheating. When the current flowing through the wire is to be cut off is determined, an overheat protection signal is output. The controller 236 outputs a current cut-off signal in response to the overheat protection signal from the overheat protection circuit 243. Here, when the controller 236 receives an overheat protection signal from the overheat protection circuit 243, the controller 236 may control the transistors 231 and 232 on or off with a higher priority than the command from the MCU 530. Further, the controller 236 may receive an overheat protection signal from the overheat protection circuit 243 by interruption processing. The transistors 231 and 232 are turned off based on a current cutoff signal. As a result, the current supply to the load 400 is cut off. On the other hand, information on the wire temperature is output to the MCU 530 via the communication interface 238.

In the semiconductor switching device 230 shown in FIG. 9, it may be realized by a logic circuit (hardware) formed on an integrated circuit (IC chip) or the like, or may be realized by software. In the latter case, the semiconductor switching device 230 includes a computer that executes instructions for a program, which is software that realizes each function. The computer includes, for example, one or more processors, and a computer-readable recording medium that stores the program. Then, in the computer, the processor reads and executes the program from the recording medium to implement the semiconductor switching device 230 described above. As the processor, for example, a CPU (Central Processing Unit) may be used. As the recording medium, a “non-temporary tangible medium”, for example, ROM (Read Only Memory) or the like, a tape, a disk, a card, a semiconductor memory, a programmable logic circuit, and the like may be used. Further, RAM (Random Access Memory) or the like for deploying the above program may be further provided. Further, the program may be supplied to the computer via any transmission medium (communication network, broadcast wave, etc.) that may transmit the program. Note that one or more embodiments may also be realized in the form of a data signal embedded in a carrier wave, where the program is embodied by electronic transmission. Further, the environmental temperature signal supplied from the MCU 530 via the ADC 239 may be supplied from the MCU 530 via the communication interface 238.

According to the semiconductor switching device of one or more embodiments described above, it may be possible to provide a semiconductor switching device that performs inexpensive and highly accurate load current square integration and wire temperature estimation while reducing resources for accurate wire temperature estimation.

Further, according to the semiconductor switching device of one or more embodiments described above, estimation of the wire temperature caused by the load current may be implemented inexpensively and accurately by installing a load current square calculator on the semiconductor switch side. For this reason, the system may be safely driven by a semiconductor switching device.

The semiconductor switching device according to one or more embodiments may be used, for example, to protect wiring such as a harness equipped in vehicles.

1. A semiconductor switching device comprising:
a switch that is connected between a power supply connected from outside of the semiconductor switching device and a load through an electric wire, and turns on and off power supply to the load;
a load current detector that detects the load current flowing through the switch; and
a square calculator that outputs a square value of the load current detected by the load current detector, wherein
the switch turns on and off the power supply to the load based on a control command.

2. The semiconductor switching device according to claim 1, further comprising:
a charge and discharge circuit that charges and discharges a capacitor connected from outside of the semiconductor switch device within a predetermined voltage range based on a square calculation result; and
a pulse output circuit that outputs a pulse signal synchronized with the switching of the charge and discharge.

3. The semiconductor switching device according to claim 1, further comprising:
an environmental temperature information acquisition circuit that obtains environmental temperature information; and
an arithmetic circuit that calculates temperature of an electric wire based on the environmental temperature information and the square value.

4. The semiconductor switching device according to claim 3, further comprising:
an overheat protection circuit that determines if protection of the electric wire is necessary based on the temperature of the electric wire calculated by the arithmetic circuit, and turns off the switch when the temperature exceeds a predetermined level.

5. The semiconductor switching device according to claim 1, wherein
the semiconductor switching device is sealed in a resin package.

6. A semiconductor switching device comprising:
a switch connected between a power supply connected from outside of the semiconductor switching device and a load via an electric wire, and turning on and off the power supply to the load;
a load current detector that detects the load current flowing through the switch;
a first analog-to-digital conversion circuit that receives the load current detected by the load current detector and performs an analog-to-digital conversion;
a square calculator that receives a digitally converted load current signal and outputs a squared value;
a second analog-to-digital conversion circuit that receives an environmental temperature signal and performs analog-to-digital conversion;
an arithmetic circuit that receives a digitally converted environmental temperature signal and the squared value, and estimates temperature of the electric wire based on the digitally converted environmental temperature signal and the squared value;
an overheat protection circuit that receives information of the estimated temperature of the electric wire and outputs an overheat protection signal when a cut off of a current flowing through the electric wire is determined; and
a controller that receives a control command from outside and controls the switch based on the control command and the overheating protection signal.

7. The semiconductor switching device according to claim 6, wherein
the arithmetic circuit comprises an electric wire thermal model circuit in which the electric wire is modeled with an electrical conductor and an insulator that insulates a conductor from outside, the electric wire thermal model circuit comprises:
a first thermal resistance, which is a thermal resistance model of the insulator;
a second thermal resistance, which is a model radiating from the insulator into space; and
a heat capacitance, which is a heat capacitance model of the conductor, wherein
the arithmetic circuit estimates temperature of the electric wire based on the square value, the electric wire thermal model circuit, and a voltage source modeled based on the environmental temperature signal.

8. The semiconductor switching device according to claim 1, wherein the square calculator comprises:
a power supply;
a first transistor comprising a base and a collector, the base and the collector electrically connected to the power supply;
a second transistor comprising a base and a collector, the base is electrically connected to an emitter of the first transistor and a first input terminal, and the collector electrically connected to the power supply;
a third transistor comprising a base electrically connected to the emitter of the second transistor and second input terminal;
a fourth transistor comprising an emitter and a collector, the emitter electrically connected to the emitter of the third transistor and a current source, and the collector connected to an output terminal;
a fifth transistor comprising an emitter and a collector, the emitter electrically connected to the base of the fourth transistor and the collector electrically connected to the current source; and
a sixth transistor comprising an emitter and a collector, the emitter electrically connected to the collector of the third transistor and the base of the fifth transistor, and the collector electrically connected to the current source.
